(19) United States
(12) Patent Application Publication
(10) Pub. No.: US 2021/0149020 A1
(43) Pub. Date: May 20, 2021

(54) A RADAR APPARATUS FOR A VEHICLE AND METHOD OF DETECTING MISALIGNMENT

(71) Applicant: ZF AUTOMOTIVE UK LIMITED, Solihull West Midlands (GB)

(72) Inventor: Rob Pinnock, Bournville, Birmingham West Midlands (GB)

(21) Appl. No.: 17/046,851

(22) PCT Filed: Apr. 18, 2019
(86) PCT No.: PCT/EP2019/060069

§ 371 Date: Oct. 12, 2020

(30) Foreign Application Priority Data
Apr. 20, 2018 (GB) 1806497.2

(51) Int. Cl. G01S 7/40; G01S 13/931; G01S 13/86

(52) U.S. Cl. CPC G01S 7/4026; G01S 2007/403; G01S 13/86; G01S 13/931

(57) ABSTRACT

A radar apparatus for use in a vehicle (10) comprises a radar sensor (16), a first 3-axis accelerometer (15) fixed so it cannot move relative to the radar sensor; and a signal processing apparatus (17) configured in use to determine a misalignment of the radar sensor by processing one or more of the signals output from the first 3-axis accelerometer with one or more signals output from at least one further sensor (14) fitted to the vehicle, in which the signal processing apparatus is arranged to process the signals using a scheme which determines any misalignment in pitch or roll of the radar sensor when the vehicle is stationary and additionally determines any offset in yaw when the vehicle is moving.

This invention relates to a method of detecting misalignment of a radar apparatus for a vehicle, and also to a radar apparatus installed in a vehicle which is capable of detecting misalignment of a radar sensor on the vehicle.

For modern advanced driver assistance (ADAS) systems using one or more in-vehicle radar sensors, there is a need continually to ensure that the radar sensor is properly aligned. If the radar sensor becomes misaligned when the vehicle is parked and the driver is absent (for example, as the result of a minor bump in a car park), then the system needs to be able to detect this misalignment automatically, either to auto-recalibrate the radar sensor if possible, or if the misalignment is too great to set the system into a degraded or non-functioning mode with appropriate driver warning. Because the radar sensor must have a clear view of the road ahead of the vehicle, or to the side or rear, it is inherently vulnerable to damage which may cause misalignment of the radar sensor. Because it is a relatively expensive component, it is also common to mount it to the vehicle in a manner that enables it to move position rather than to break, allowing for the sensor position to be reset at a later time which is preferable to replacing a broken sensor.

Radar sensor misalignment detection is currently achieved by doing statistical analysis of the position of target objects other vehicles, etc as detected by the radar sensor when the vehicle is being driven. The expected statistical distribution of these targets is known, and if it is found to be different, a suitable correction can be applied. The main shortcoming of this approach is that, depending on the pertaining driving scenario and particularly the number of suitable targets, it can take quite a long time to build up sufficient statistical confidence in the measure of misalignment. The aim for future misalignment detection systems is to detect any misalignment within a few seconds of driving off, whatever the driving scenario.

A further disadvantage of all known prior art based on measurements from linear accelerometers is that, in order to detect Z axis azimuthal (yaw) misalignment of the radar sensor module, i.e. rotational misalignment around the vertical Z axis, the vehicle must be moving and accelerating straight ahead so that, in the presence of azimuthal misalignment of the radar sensor, a component of the vehicle's longitudinal X axis acceleration is coupled into the accelerometer that is nominally detecting the Y axis lateral acceleration in the radar module. Since this driving situation might not occur for some time after drive off, the vehicle may travel for some distance before the misalignment of the radar sensor is detected.

An object of the present invention is to provide a method and apparatus that overcomes the shortcomings of the prior art.

According to a first aspect the invention provides a radar apparatus for use in a vehicle, the apparatus comprising:

a radar sensor,

a first 3-axis accelerometer fixed in position relative to the radar sensor; and

a signal processing apparatus configured in use to determine a misalignment of the radar sensor by processing one or more of the signals output from the first 3 axis accelerometer with one or more signals output from at least one further sensor that is fixed in position relative to the vehicle, in which the signal processing apparatus is arranged to process the signals using a scheme which determines any misalignment in pitch or roll of the radar sensor when the vehicle is stationary and additionally determines any offset in yaw when the vehicle is moving.

The further sensor may comprise a second accelerometer, preferably a 2 axis (x,y) or 3 axis (x,y.z) accelerometer that is fixed to the vehicle offset from the first 3 axis accelerometer.

The further sensor may additionally or alternatively comprise a yaw rate sensor that is oriented on the vehicle to detect any yaw of the vehicle. This may be fixed directly to the vehicle or fixed to a housing for the yaw rate sensor.

The invention may comprise in combination the radar apparatus and the one or more further sensors fitted to a vehicle to form a complete system.

The provision of a further sensor in the form of a 2 or 3 axis accelerometer enables the signal processing apparatus to derive the value of any pitch and roll misalignment of the radar sensor while the vehicle is still stationary after ignition on. In general, a “misalignment event” will cause angular misalignment of the radar module to some extent around all three axes, rather than just one or two: hence, for most cases, this capability gives an indication that the radar has become misaligned before the vehicle drives off.

The signal processing apparatus may use a combination of the measurements, i.e. output signals, from the yaw rate sensor and the two 3-axis linear accelerometers to determine azimuthal misalignment of the radar sensor to be determined whatever the driving situation (straight or curved motion of the vehicle).

The prior determination of any pitch and/or roll misalignment enables any cross-axial errors to be removed, giving a more accurate derivation of azimuthal misalignment. In the unlikely event that the misalignment comprises only rotation around the z axis (purely azimuthal misalignment), then the signal processing apparatus can similarly determine this in any driving scenario. By this we mean not just straight-line driving subject only to the requirement that the vehicle's acceleration needs to be above some threshold level.

The first 3 axis accelerometer may be fixed relative to the radar sensor such that misalignment of the radar sensor is accompanied by misalignment of the first 3 axis accelerometer. It may be integral with the radar sensor, for instance in a common radar sensor housing.

The apparatus may in use when fitted to a vehicle by aligned so that the 3 axes of the first accelerometer X, Y and Z respectively lie on the longitudinal, lateral and vertical axes of the vehicle when vehicle is on a level region of road.

Similarly, the second 2 or 3 axis accelerometer may have axes X, Y and optionally Z aligned with those same axes on the vehicle.

In any event, when perfectly aligned the 3 axes of the first 3 axis accelerometer may be aligned with corresponding axes of the second accelerometer.

The two accelerometers may be located at a known distance apart, the distance being stored in a memory of the radar apparatus accessible to the signal processing apparatus for use during the determining of any yaw misalignment.

The scheme employed by the signal-processing unit as the vehicle is moving along a curvi-linear path may employ the equations set out later in this specification, in particular:

A_{Vy}−A_{Fy}+(r_{Fx}−r_{Vx})·\dot{ω}_{z}=0

And

(A_{Vx}−A_{Fx})−(r_{Fx}−r_{Vx})·ω_{z}²=0

Where Aᵥ and A_{F} are accelerations for the second accelerometer fixed to the vehicle body and to the first accelerometer fixed relative to the radar sensor respectively, and r_{F} and rᵥ [r_{Fx} and r_{Vx}] are positions of the two accelerometers relative to one another and w_{z} is the angular velocity, °/s relative to the vertical z axis of the vehicle body.

The signal processing apparatus may be configured to determine that a misalignment due to yaw is present if the two equations noted above are not satisfied when processing the signals captured from the two accelerometers and from the yaw rate sensor. i.e. one or other equations does not sum to zero.

The apparatus may determine if there has been a misalignment of the radar sensor for roll or pitch by comparing the accelerations measured for the X and Y axes of both sensors when the vehicle is stationary, and in the event that they differ determining that there is a misalignment.

According to a second aspect the invention provides a method of detecting misalignment, or checking for the correct alignment, of a radar sensor of a radar apparatus of a vehicle, the method comprising:

at a time when the vehicle is stationary:

Capturing a first set of acceleration signals output for three orthogonal axes of a 3 axis accelerometer which is fixed in positon relative to the radar sensor,

Capturing a second set of acceleration signals output for at least two axes of a second, reference, 2 or 3 axis accelerometer fixed in position relative to the body of the vehicle,

And processing the captured signals to determine any misalignment of the radar sensor corresponding to roll or pitch of the radar sensor relative to the vehicle body; and

At a time when the vehicle is moving along a curvi-linear path:

Capturing a third set of acceleration signals output from the three axes of a 3 axis accelerometer which is fixed in positon relative to the radar sensor,

Capturing a fourth set of acceleration signals output for at least two axes and preferably three axes of a second, reference, 2 or 3 axis accelerometer fixed in position relative to the body of the vehicle,

Capturing a measure of the yaw rate of the vehicle,

And processing the third and fourth sets of captured acceleration signals and the yaw rate signal to determine any misalignment of the radar sensor corresponding to yaw misalignment of the radar module relative to the body of the vehicle.

Preferably the second set of acceleration signals correspond to each of the three orthogonal axes of a 3-axis accelerometer. The applicant has appreciated that the measurement of the linear acceleration in all three axes is required to derive accurate tilt measurements: for small misalignments, the deviation of the z-axis acceleration from g will be small, but the vehicle might for example be parked on a steep slope where the errors will be greater if the actual resultant vertical acceleration is not known.

The first and second sets of values of signals may comprise the X and Y axes of each sensor which may each be aligned with the longitudinal and lateral axes of the vehicle body respectively when the radar sensor is correctly aligned. If not aligned with the respective longitudinal and lateral axes, these two axes may otherwise lie in a horizontal plane when the radar sensor is in an ideal alignment and the vehicle is stationary on a horizontal surface.

The method of the second aspect may therefore detect both pitch and roll misalignment with the vehicle stationary, and detect azimuthal misalignment by comparing signals captured when the vehicle is moving.

Where the radar housing is initially installed so that the X-axis of the first 3 axis accelerometer is aligned with the longitudinal axis of the vehicle, and the X-axis of the second 3-axis accelerometer is also aligned with that same axis, roll caused by the rapid movement of the vehicle about the longitudinal axis will not cause any change in the output of the X-axis of the first 3 axis accelerometer. If there is a change, this will indicate that the radar sensor is misaligned so that its nominal X-axis is not lying correctly on the longitudinal axis of the vehicle.

The method may comprise generating one or more offset values to be applied to the output of one or more axes of the first 3 axis accelerometer to compensate for any misalignment that is detected during the method. An offset value may be derived for each of the 3 signals output from the first 3 axis accelerometer.

The method may in particular employ the following equations to determine if there is a misalignment in yaw:

A_{Vy}−A_{Fy}+(r_{Fx}−r_{Vx})·\dot{ω}_{z}=0

And

(A_{Vx}−A_{Fx})−(r_{Fx}−r_{Vx})·ω_{z}²=0

There will now be described, by way of example only, one embodiment of the present invention with reference to the accompanying drawings of which:

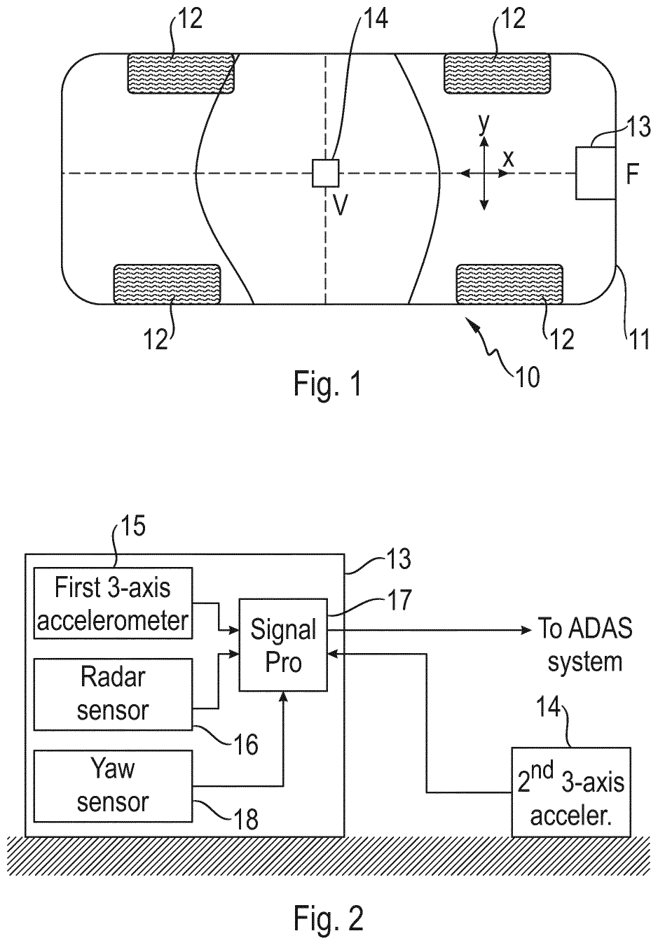

FIG. 1 shows an embodiment of a radar apparatus within the scope of the first aspect of the present invention fitted to a vehicle;

FIG. 2 shows in more detail the component parts of the apparatus and how they are interconnected electrically and to the vehicle body;

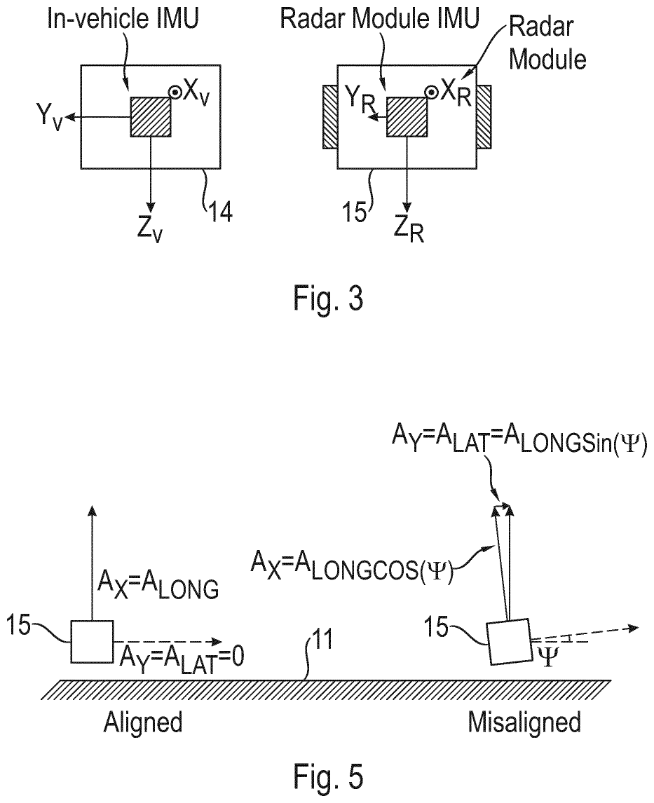

FIG. 3 shows in more detail the ideal initial alignment of the radar sensor and the first and second 3 axis accelerometers of the apparatus of FIG. 1;

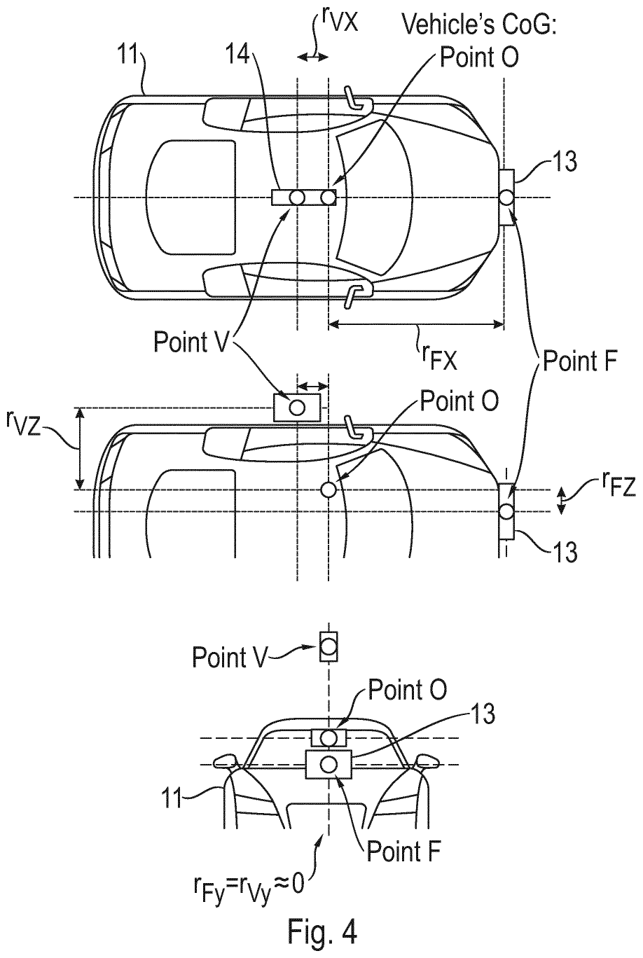

FIG. 4 shows the sensors fitted to the vehicle in a plan view and from the front identifying the various frames of reference and positions of the sensors within those frames; and

FIG. 5 shows the effect of a misalignment of the radar sensor.

FIGS. 1 to 3 show an embodiment of a radar apparatus in accordance with a first aspect of the present invention fitted to a vehicle 10. The vehicle is shown in plan from above and has four road wheels 12; two front wheels and two rear wheels. The vehicle has a defined longitudinal axis represented as a dashed line that is denoted here as the X axis which is aligned with the direction of travel of the vehicle when moving forward in a straight line. Any rotation around this axis will cause roll of the vehicle. It has a lateral axis that is orthogonal to the direction of travel when moving in a straight line that is denoted here as the Y axis and again indicated by a dotted line. The vehicle will rotate around this axis when accelerating and decelerating as the vehicle pitch changes. It also has a vertical Z axis and the vehicle will rotate around this to create yaw as the vehicle turns a corner. The Z axis is not marked in FIG. 1 as it extends orthogonally out of the plane of the figure.

Fitted to the front of the body 11 of the vehicle is a radar housing 13 which houses a radar sensor 16. A first 3-axis accelerometer 15 is housed in the housing 13 so it cannot move relative to the radar sensor 16. The radar housing 13 is secured to the vehicle body.

A signal processing apparatus 17 receives as an input the 3 axis output signals from the first 3 axis accelerometer 15 that is located inside the radar housing 13. In this example the accelerometer is located in the housing so that the 3 axes X, Y and Z of the accelerometer are aligned with the X, Y and Z axes of the vehicle when the radar sensor is perfectly aligned. This can best be seen in FIG. 1.

The signal processing apparatus 17 also receives three output signals from a second 3 axis accelerometer 14 fitted to the vehicle. This also has the three axes X, Y and Z aligned with the corresponding axes of the vehicle. It is located away from the radar housing so that it cannot be misaligned when the housing is misaligned and provides a frame of reference. This is shown in FIG. 3 and FIG. 4 of the accompanying drawings. Although shown as being at the CoG of the vehicle this is not essential in all embodiments that may be considered within the scope of the present invention. A yaw sensor 18 is also provided and the output of the yaw sensor is fed to the signal processing apparatus. As shown this sensor is provided within the radar housing but it may be provided elsewhere on the vehicle, for example alongside the second accelerometer.

Each of 3 axis accelerometers 14,15 will each typically comprise a vehicle inertial measurement unit (IMU) which includes the 3 axis sensing element and a signal processing unit that derives 3 acceleration signals from the sensing elements. To reduce shock the IMU may mount the sensing elements using shock-absorbing mountings, allowing the effects of high frequency noise to be eliminated prior to any electronic signal processing if desired. Suitable IMUs are widely available commercially for use in automotive applications.

The signal processing apparatus 17 is configured in use to determine a misalignment of the radar sensor 16 by processing the outputs of the first and second 3 axis accelerometers when the vehicle is at rest, and the outputs of the first and second 3 axis accelerometers and the yaw rate sensor when it is moving along any curvilinear path.

Method of Operation

The method of detection of angular misalignments of the radar sensor occurs in two phases:

Phase (i) when the vehicle is stationary. For example this may be at a time upon ignition on, but before driving off. When stationary the apparatus statically determines the pitch and roll angles of both the radar sensor and the vehicle itself, using the individual accelerometers in each case;

Phase (ii) within a short time after driving off, the apparatus dynamically determines if any difference in azimuthal (yaw) alignment of the two 3 axis accelerometers is present. This phase, importantly, uses a scheme as set out below that is operable even when the vehicle is moving along a curved path.

Note that the proposed system only seeks to correct angular misalignments of the radar module, and not misalignment arising from any linear translation.

Phase (i) Detection of Pitch and Roll Angular Misalignment

Upon ignition on, but before driving off, the acceleration measurements from the IMU mounted in the radar module are compared with those measured by the separate in-vehicle IMU mounted at or close to the vehicle's yaw centre or centre of gravity (note: the in-vehicle IMU does not necessarily have to be at even or close to the CoG of the vehicle, but just sufficiently separated from the radar sensor IMU to ensure that it doesn't itself suffer misalignment when the radar sensor becomes misaligned). After compensating for any effects arising from (i) sensor offsets and drifts (through the use of stored calibration data), and (ii) the physical separation of the two IMUs, the x, y and z linear accelerations (due to gravitational acceleration, since the vehicle is not moving) measured by the individual IMUs can be used to derive radar module and vehicle pitch (θ_{R}, θ_{V}) and roll (ϕ_{R}, ϕ_{V}) angles. If the derived radar module and vehicle pitch and roll angles θ_{R}, θ_{V} and ϕ_{R}, ϕ_{V}, derived from the acceleration measurements from the two IMUs, match each other, then it can be assumed that no pitch or roll misalignment of the radar module has occurred during the period when the vehicle was parked prior to ignition on. If either or both the pitch and roll angles derived from the two IMUs do not match, then it can be assumed that misalignment of the radar module has occurred during the period in which the vehicle was parked, prior to ignition on. In this case, either: (i) appropriate corrections can be applied to the subsequent radar module measurements in software, to account for the pitch and roll misalignment of the radar module; (ii) in the case of too large a misalignment discrepancy, the radar system can be shut down and the driver alerted.

It is possible that, even though no pitch or roll misalignment has been detected, purely azimuthal (yaw) misalignment ψ_{R} of the radar module may have taken place. If so, the present concept enables this also to be detected within a very short time after driving off, as follows.

Detection of Azimuthal (Yaw) Angular Misalignment

In the simplest case, imagining the vehicle to accelerate away from stationary in a perfectly straight line on a perfectly level road, any azimuthal misalignment ψ_{R} of the radar module will cause some of the longitudinal (x axis) vehicle acceleration to be cross-coupled into the lateral (y-axis) accelerometer axis of the radar module's IMU. For the longitudinal acceleration coupled into the radar module's lateral accelerometer, the change in coupled signal is simply the longitudinal acceleration A_{LONG} times the sine of the misalignment angle ψ_{R}:

δA_{LAT}=A_{LONG}·sin(ψ_{R})

After misalignment, the longitudinal acceleration sensed by the longitudinal accelerometer in the radar module becomes A_{LONG}·cos(ψ_{R}), and hence:

$$tan ( {ψ}_{R} ) = \frac{{A}_{LAT}}{{A}_{LONG}}$$

A method as outlined above is known from U.S. Pat. No. 9,366,751B2 for detecting azimuthal angular misalignment of the radar sensor. However, the method taught in that citation is only appropriate for the case where the vehicle is acceleration (or decelerating) in a perfectly straight line on a perfectly flat road and where the acceleration is low enough for there to be negligible pitch of the vehicle. If the road is not perfectly flat—for example, it has a camber—or the acceleration is to great, then some component of the acceleration due to gravity will be couple into both the lateral accelerometer and (if the radar module is azimuthally misaligned) into the longitudinal accelerometer of the radar module's IMU. Further, if the vehicle has any yaw rotation at all, then this will also affect the acceleration measurements of the IMUs, as described below. Since, for a small azimuthal angular misalignment of the radar module, for example, the magnitude of the component of longitudinal acceleration cross-coupled into the lateral accelerometer will be correspondingly small, the above technique will not in general work well, since perfectly straight motion on a perfectly level road surface is never achieved in practice, and in all other circumstances, additional cross-coupling influences, and effects due to vehicle yaw, must be taken into account.

In the method that may be performed by the apparatus shown in FIG. 1 that falls within the scope of an aspect of the invention, the signal processing unit is arranged to apply alternate processing of the signals to permit a rapid determination of offset to be made when the vehicle is travelling along any curvilinear path, not simply when it is travelling in a straight line.

The following description sets out the equations that may be applied by the signal processing apparatus to enable rapid detection of azimuthal angular misalignment of the radar module for any general curvilinear motion of the vehicle from an initial stationary position.

The acceleration vector of a fixed reference point P somewhere on a rigid body, moving in an inertial reference frame, comprises: (i) the acceleration of the origin of the body-fixed reference frame; (ii) the tangential and centripetal accelerations at the reference point P arising from any rotation of the rigid body; (iii) the acceleration (including Coriolis acceleration) of the reference point with respect to the rigid body:

\vec{A_{P}}=\vec{A₀}+\vec{a_{P}}+2\vec{ω}×\vec{v_{P}}+\vec{w}×(\vec{w}×\vec{r_{P}})+\dot{\vec{w}}×\vec{r_{P}} Equation 1

where:

\vec{A_{P}} is the acceleration vector of the reference point P

\vec{A₀} is the acceleration vector of the origin O of the body-fixed reference frame with respect to the inertial reference frame

\vec{a_{P}} is the acceleration vector of P relative to the body-fixed reference frame

\vec{v_{P}} is the velocity vector of P relative to the body-fixed reference frame

\vec{ω} is the angular velocity of the rigid body

\dot{\vec{ω}} is the angular acceleration of the rigid body

\vec{r_{P}} is the position vector of P with respect to the origin O of the body-fixed reference frame.

The point P may be any point on (or within) the rigid body where it is possible to place sensors to measure the motion characteristics of the body: in the present case, the vehicle represents the rigid body, and the places on the vehicle where the front-mounted and vehicle-mounted sensor modules are placed represent two possible such points.

If, as in the present case, the point P is fixed with respect to the rigid body, then both \vec{a_{P}} and \vec{v_{P}} are zero, so that both the term \vec{a_{P}} and the Coriolis acceleration term 2\vec{w}×\vec{v_{P}}=0. Equation 1 then reduces to:

\vec{A_{P}}=\vec{A₀}+\vec{w}×(\vec{w}×\vec{r_{P}})+\dot{\vec{w}}×\vec{r_{P}} Equation 2

Equation 2 may be expanded (by multiplying out the vector cross products), rearranged, and separated into x, y and z components as follows:

A₀ₓ=A_{Px}+rₓ(ω_{y}²+ω_{z}²)−r_{y}(ωₓω_{y}−\dot{ω}_{z})−r_{z}(ωₓω_{z}−\dot{ω}_{y}) Equation 3a

A_{0y}=A_{Py}−rₓ(ωₓω_{y}+\dot{ω}_{z})+r_{y}(ωₓ²+ω_{z}²)−r_{z}(ω_{y}ω_{z}−\dot{ω}ₓ) Equation 3b

A_{0z}=A_{Pz}−rₓ(ωₓω_{z}−\dot{ω}_{y})−r_{y}(ω_{y}ω_{z}+\dot{ω}ₓ)+r_{z}(ωₓ²−ω_{y}²) Equation 3c

The vector \vec{r_{P}} extends from the origin O to the point P on the rigid body where the motion characteristics can be measured. In general, it is not possible to measure the motion characteristics actually at the origin O of the rigid body's reference frame.

Equations 3a, 3b and 3c may now be considered in terms of the present sensor configuration. In this case, the position of the point O (the CoG of the vehicle) relative to the positions of the two sensor modules, Point F and Point V, is not known. However, the sensors are positioned such that it is expected that their axes are either (approximately) coincident with, or at least parallel with, the vehicle axes.

As shown in the figures, for this exemplary arrangement r_{Fy}=r_{Vy}≈0, since both sensor modules are mounted on the longitudinal axis through the centre of the vehicle. If a further approximation is made—that only angular motion around the vertical axis is significant, and that therefore ox and oy are both zero, then Equations 3a, 3b and 3c become:

A₀ₓ=A_{Fx}+r_{Fx}(ω_{z}²) Equation 4a

A₀ₓ=A_{Vx}+r_{Vx}(ω_{z}²) Equation 4b

A_{0y}=A_{Fy}−r_{Fx}(\dot{ω}_{z}) Equation 4c

A_{0y}=A_{Vy}−r_{Vx}(\dot{ω}_{z}) Equation 4d

A_{0z}=A_{Fz} Equation 4e

A_{0z}=A_{Vz} Equation 4f

Equating A₀ₓ, A_{0y} and A_{0z} in the relevant pairs of equations gives:

A_{Vx}=A_{Fx}+(r_{Fx}−r_{Vx})·\dot{ω}_{z}² Equation 5a

A_{Vy}=A_{Fy}−(r_{Fx}−r_{Vx})·\dot{ω}_{z} Equation 5b

A_{Vz}=A_{Fz} Equation 5c

Although in the present instance the position of the vehicle's CoG is unknown, the value of the factor (r_{FX}−r_{VX}) represents simply the distance between the two sensor modules (note that, according to the way r_{FX} and r_{VX} are defined in this example r_{VX} is negative with respect to r_{FX}). This distance can be defined at the initial vehicle/system design stage, or simply be measured.

As noted above, the simplified equations 5a, 5b and 5c utilize certain assumptions about the way the system is configured and the expected motion of the vehicle: however, the full equations could equally be used if, for example, a more comprehensive sensor suite were employed—e.g. to measure rotary motion around the other two axes.

Equation 5b can be rearranged as follows:

A_{Vy}−A_{Fy}+(r_{Fx}−r_{Vx})·\dot{ω}_{z}=0 Equation 6a

Since (A_{Vy}−A_{Fy}) represents the difference in measured lateral acceleration as measured by the radar module's IMU and the vehicle-mounted IMU, it is clear why the analysis described earlier will only work for perfectly linear motion of the vehicle: there is an additional term (r_{Fx}−r_{Vx})·dω/dt which must also be taken into account: since, for small angular misalignments, (A_{Vy}−A_{Fy}) is expected to be small, then it is necessary to account for even small values of rate of change of yaw rate (angular acceleration) do/dt in order for the system to give accurate results.

Similarly, Equation 5a can be rearranged as:

(A_{Vx}−A_{Fx})−(r_{Fx}−r_{Vx})·ω_{z}²=0 Equation 6b

In this case, (A_{Vx}−A_{Fx}) represents the difference in measured longitudinal acceleration as measured by the radar module's IMU and the vehicle-mounted IMU. Once again there is an additional yaw-rate-dependent term (r_{Fx}−r_{Vx})·ω_{z}² which must be taken into account for the system to give accurate results.

If the measurements from the accelerometers confirm both Equations 6a and 6b, then this confirms that there is no azimuthal misalignment between the two sensor modules.

If Equations 6a and 6b are not confirmed by the accelerometer measurements—that is, either:

A_{Vy}−A_{Fy}+(r_{Fx}−r_{Vx})·\dot{ω}_{z}≠0

or

(A_{Vx}−A_{Fx})−(r_{Fx}−r_{Vx})·ω_{z}²≠0

or both, then azimuthal misalignment of the radar module has occurred.

In order to correct for this misalignment, it is important to know its magnitude—that is, the value of the azimuthal misalignment angle ω_{R}, given by:

$$tan ( {ψ}_{R} ) = \frac{{A}_{LAT \_ residual}}{{A}_{LONG}} and tan ( {ψ}_{R} ) = \frac{{A}_{LONG \_ residual}}{{A}_{LAT}} \qquad Equation 6 c$$

respectively for straight and circular vehicle motions, where A_{LAT_residual} and A_{LONG_residual} represent the yaw-corrected residual lateral and longitudinal accelerations (both zero in the case of zero azimuthal misalignment of the radar module). In the general curvilinear motion case, both values of residual acceleration can be continually monitored to enable the value of azimuthal misalignment angle ψ_{R} to be derived for any driving scenario.

Additional Effects of Vehicle Roll and Pitch

In principle, the equations derived above will give the correct results for any general curvilinear motion of the vehicle from standstill. However, for curvilinear motion where the angular velocity and acceleration are sufficiently large, an additional complicating factor is that the vehicle rolls during its travel. In the presence of azimuthal misalignment of the radar module, these angular deviations of the vehicle cause some cross-coupling of the acceleration due to gravity into its lateral and longitudinal accelerometers. Similarly, and changes in vehicle pitch during travel will cause a pitch-induced cross-coupling of gravitational acceleration.

For the case where the motion of the vehicle involves relatively small angular velocity and angular acceleration—that is, for some values of ω and dω/dt less than some threshold values ω_{THRESH} and dω/dt_{THRESH} as measured by the yaw rate sensor, then the analysis described previously will yield a sufficiently accurate measure of azimuthal angular misalignment.

More generally, vehicle roll and pitch effects may need also to be taken into account. The body of a vehicle travelling in a curved trajectory will roll and pitch to an extent which depends on the linear and angular velocity and acceleration characteristics of the vehicle, and the physical characteristics of the vehicle and road surface. In general, for a perfectly aligned sensor module, vehicle roll will have no effect on the measured longitudinal acceleration, since the roll axis is in this case exactly aligned with the longitudinal direction. Similarly, vehicle pitch will have no effect on the measured lateral acceleration for a perfectly aligned sensor.

If the radar module has some azimuthal misalignment, then the effect of vehicle roll is to cause a component of the gravitational acceleration to appear in the measured longitudinal acceleration signal. This may be significant because the gravitational acceleration is generally several times larger than any component of actual vehicle acceleration.

Note: the assumption made above in deriving Equations 4a-4f, that ωₓ and ω_{y} are both zero, is not true if the vehicle is rolling or pitching in its motion. However, the analysis has shown that, for typical vehicle motion, the errors introduced by ignoring the terms involving ωₓ and ω_{y} in Equations 3a to 3c are small.

If a sensor module, having a yaw misalignment angle ψ, is subjected to an additional roll angle ϕ then (assuming no other angular effects or misalignments are present) the magnitude of the component of gravitational acceleration appearing in the longitudinal axis is given by:

δA_{Grav_Roll}=g·sin ϕ sin ψ Equation 7a

Hence, from Equation 5a:

A_{Vx}−g·sin ϕ sin ψ_{V}=A_{Rx}−g·sin ϕ sin ψ_{R}+(r_{Rx}−r_{Vx})·ω_{z}²

where ω_{V} and ψ_{R} are respectively the yaw angular misalignments of the vehicle-mounted and radar-mounted sensor modules respectively. Hence:

$$sin {ψ}_{V} - sin {ψ}_{R} = \frac{{A}_{Vx} - {A}_{Rx} - ( {r}_{Rx} - {r}_{Vx} ) {ω}_{z}^{2}}{g . sin φ} \qquad Equation 7 b$$

Equation 7b cannot be solved uniquely for unknown ψV and ψF. However, in a properly engineered production system, it can be assumed that the in-vehicle sensor will be installed such that its axes are closely aligned with those of the vehicle: hence, in this case, ψ_{V}≈0, and Equation 7b can be solved for ψ_{R} if the roll angle ϕ is measured.

With the assumption ψ_{V}≈0 in the zero position, Equation 7b gives:

$${ψ}_{R} = {sin}^{- 1} ( \frac{{A}_{Vx} - {A}_{Rx} - ( {r}_{Rx} - {r}_{Vx} ) . {ω}_{z}^{2}}{g . sin φ} ) \qquad Equation 7 c$$

where ψ_{R} is the yaw angular misalignment of the radar module (with respect to the vehicle-mounted sensor module).

Note that Equation 7c becomes unstable as the vehicle roll angle ϕ→0, so will only yield stable results when the angular motion of the vehicle (or the road camber) is sufficiently large to produce a roll angle above some threshold ϕ_{THRESH}. However, for small roll angles, Equation 6c will generally yield a sufficiently accurate measure of the azimuthal angular misalignment angle ψ.

Similar analysis for pitch angular deviation θ of the vehicle yields an additional component δA_{Grav_Pitch}=g·sin θ sin ψ added to the acceleration appearing in the lateral acceleration axis of the azimuthally-misaligned radar module. This additional component may similarly be taken into account when deriving the azimuthal angular misalignment angle ψ.

Note that any initial roll and pitch angles of the vehicle are accounted for by the initial static measurements of roll and pitch angle and zeroing of the system at ignition on.

The method and apparatus within the scope of the present invention provide as a principal advantage a full characterization of the alignment of the radar module, including detection of any azimuthal misalignment, for any motion of the vehicle from drive off, both linear or curvilinear, within a few seconds from drive off provided that certain small thresholds of vehicle roll/pitch re achieved for Equation 8 to be stable. In the prior art, derivation of azimuthal misalignment of the radar module requires the vehicle to be accelerating ahead in an absolutely straight line, which may not occur until the vehicle has travelled some considerable distance, and may never actually occur in practice.

A further advantage of the proposed concept is that it requires no very accurate initial positioning of the radar module, since the initial end of vehicle production line misalignments between the two IMUs, provided these are not too large, can be measured, and appropriate software corrections implemented.

1. A radar apparatus for use in a vehicle, the apparatus comprising:
a radar sensor,
a first 3-axis accelerometer fixed in position relative to the radar sensor; and
a signal processing apparatus configured in use to determine a misalignment of the radar sensor by processing one or more of the signals output from the first 3 axis accelerometer with one or more signals output from at least one further sensor that is fixed in position relative to the vehicle, in which the signal processing apparatus is arranged to process the signals using a scheme which determines any misalignment in pitch or roll of the radar sensor when the vehicle is stationary and additionally determines any offset in yaw when the vehicle is moving.

2. A radar apparatus according to claim 1 in which the further sensor comprises a second accelerometer, preferably a 2 axis (x,y) or 3 axis (x,y.z) accelerometer that is fixed to the vehicle offset from the first 3 axis accelerometer.

3. A radar apparatus according to claim 2 in which the further sensor additionally or alternatively comprises a yaw rate sensor that is oriented on the vehicle to detect any yaw of the vehicle.

4. A radar apparatus according to claim 2 in which the signal processing apparatus in use derives the value of any pitch and roll misalignment of the radar sensor while the vehicle is stationary.

5. A radar apparatus according to claim 2 in which the signal processing apparatus is configured in use to combine the output signals from the yaw rate sensor and the two accelerometers to determine azimuthal misalignment of the radar sensor to be determined when the vehicle is moving.

6. A radar apparatus according to claim 1 in which the first 3 axis accelerometer ise fixed relative to the radar sensor such that misalignment of the radar sensor is accompanied by misalignment of the first 3 axis accelerometer.

7. A radar apparatus according to claim 1 in which the two accelerometers are located at a known distance apart, the distance being stored in a memory of the radar apparatus accessible to the signal processing apparatus for use during the determining of any yaw misalignment.

8. A radar apparatus according to claim 1 in which the signal processing apparatus is arranged to determine if there is a misalignment in yaw in the event that one or both of the following two equations are not satisfied:
A_{Vy}−A_{Fy}+(r_{Fx}−r_{Vx})·\dot{ω}_{z}=0
And
(A_{Vx}−A_{Fx})−(r_{Fx}−r_{Vx})·ω_{z}²=0
Where Aᵥ and A_{F} are accelerations for the second accelerometer fixed to the vehicle body and to the first accelerometer fixed relative to the radar sensor respectively, and r_{F} and rᵥ [r_{Fx} and r_{Vx}] are positions of the two accelerometers relative to one another and w_{z} is the angular velocity, °/s relative to the vertical z axis of the vehicle body.

9. A method of detecting misalignment, or checking for the correct alignment, of a radar sensor of a radar apparatus of a vehicle, the method comprising:
at a time when the vehicle is stationary:
Capturing a first set of acceleration signals output for three orthogonal axes of a 3 axis accelerometer which is fixed in position relative to the radar sensor,
Capturing a second set of acceleration signals output for at least two axes of a second, reference, 2 or 3 axis accelerometer fixed in position relative to the body of the vehicle,
And processing the captured signals to determine any misalignment of the radar sensor corresponding to roll or pitch of the radar sensor relative to the vehicle body; and
At a time when the vehicle is moving along a curvi-linear path:
Capturing a third set of acceleration signals output from the three axes of a 3 axis accelerometer which is fixed in position relative to the radar sensor,
Capturing a fourth set of acceleration signals output for at least two axes and preferably three axes of a second, reference, 2 or 3 axis accelerometer fixed in position relative to the body of the vehicle,
Capturing a measure of the yaw rate of the vehicle,
And processing the third and fourth sets of captured acceleration signals and the yaw rate signal to determine any misalignment of the radar sensor corresponding to yaw misalignment of the radar module relative to the body of the vehicle.

10. A method according to claim 9 in which the second set of acceleration signals correspond to each of the three orthogonal axes of a 3-axis accelerometer.

11. A method according to claim 9 in which the first and second sets of values of signals comprise the X and Y axes of each sensor which may each be aligned with the longitudinal and lateral axes of the vehicle body respectively when the radar sensor is correctly aligned.

12. A method according to claim 9 comprising determining if the the following equations are satisfied to determine if there is a misalignment in yaw:
A_{Vy}−A_{Fy}+(r_{Fx}−r_{Vx})·\dot{ω}_{z}=0
And
(A_{Vx}−A_{Fx})−(r_{Fx}−r_{Vx})·ω_{z}²=0
